(19) United States
(12) Patent Application Publication
(10) Pub. No.: US 2008/0156207 A1
(43) Pub. Date: Jul. 3, 2008

(54) Stencil printers and the like, optical systems therefor, and methods of printing and inspection

(76) Inventor: Dan Ellenbogen, Modiin (IL)

Correspondence Address: NATH & ASSOCIATES, PLLC, 112 South West Street, Alexandria, VA, 22314, US

(21) Appl. No.: 11/646,576

(22) Filed: Dec. 28, 2006

(51) Int. Cl. B41M 1/12; B41L 13/00

(52) U.S. Cl. 101/126; 101/129; 101/481

(57) ABSTRACT

An optical system for use with printers and the like, printers incorporating such optical systems, methods for printing substrates and for inspection thereof are provided. The optical system may include one or more image capturing devices, and an image processing device for processing images captured by the image capturing devices to provide image data. The optical system is adapted for providing image data corresponding to at least two capture areas of substantially different dimensions on a common focusing plane or on different focusing planes of the optical system.

### FIELD OF THE INVENTION

This invention relates to optical systems for stencil printers and the like, and to such printers incorporating optical systems, and also to methods for printing substrates and for inspection thereof.

### BACKGROUND OF THE INVENTION

Stencil printers are widely used for screen printing on a substrate, for example of a solder paste or the like on a circuit board, enabling electronic components to be subsequently mounted to the board. A stencil is provided having apertures corresponding to the particular pattern of solder that is required for a particular board, and the printing material is deposited on the board via the stencil apertures to produce the pattern thereat.

The stencil printing process generally involves an initial alignment step between the stencil and the unprinted board, to ensure that the stencil apertures are superposed over the desired areas of the board. Alignment is commonly performed by means of an optical system.

U.S. Pat. No. 5,060,063 discloses an illuminated video probe in an aligning system for simultaneously viewing an object and a device acting on the object while illuminating the object and the device acting on the object directly along their respective viewing axes. A first optical beam splitter and adjacent mirror surface act to simultaneously translate the object and device images to the video probe optical axis. A second optical beam splitter, adjacent light source, and opaque surface act to illuminate the object along the viewing axis without causing light to project back toward the video probe.

Re 35,615 discloses an aligning system that includes an object to be acted upon at predetermined locations, such as a circuit board to receive solder paste. There is a device, such as a stencil, characterized by the pattern for acting upon the object. A video probe is arranged to look at both the device and the object for providing image signals representative of both. A comparator compares the image signals to provide an error signal representative of misalignment between the device and object. A positioner responsive to the error signal relatively positions the device and object to reduce the error. An operator causes the device to operate upon the object at the predetermined locations.

In U.S. Pat. No. 7,013,802, a video probe similar to that of U.S. Pat. No. 5,060,063 or Re 35,615 is used for aligning a board with a stencil: when these components are spaced from one another, the probe is inserted into this space to assist in the alignment, and the probe is then horizontally removed from this space before the board and stencil can be brought vertically together for printing.

In some printers, the printed board is inspected after printing. For example, in U.S. Pat. No. 7,013,802, the stencil and printed board are separated after printing, and the probe is moved back into its former position over the board to inspect the same.

U.S. Pat. No. 6,748,289 relates to a control method for improving the productivity of a screen printer for an electronics-mounting machine. A screen printer uses a recognition camera to inspect the results of printing of a circuit board concurrently with a cleaning operation of the rear surface of a screen. This screen printer also enables cream solder to be automatically supplied to reduce the operation time by determining whether the next screen to be used is unused. During automatic screen replacement, this screen printer enables a desired screen stored in the corresponding stocker to be automatically specified in order to replace the current screen in response to a selected NC program.

### SUMMARY OF THE INVENTION

According to one aspect of the invention, an optical system is provided for use with printers and the like, comprising:
at least one image capturing device and an image processing device for processing images captured by the or each said image capturing device to provide image data;
a positioning mechanism for positioning the or each said image capturing device into optical alignment with respect to at least one position on at least one focusing plane associated with the printer to enable images to be captured thereat;
wherein the optical system is adapted for providing said image data corresponding to at least two capture areas of substantially different dimensions on a same or different said at least one focusing plane.

The at least two capture areas may include a first capture area and a second capture area, wherein said first capture area is dimensionally larger than said second capture area. In some embodiments, the resolution of the image data relating to the second capture area may be greater than the resolution of the image data relating to the first capture area.

The positioning mechanism may be configured for translating said at least one image capturing device along a plane substantially orthogonal to a viewing direction thereof, and for enabling said at least one image capturing device to become optically aligned with and capture images of a plurality of positions on said at least one focusing plane to provide a plurality of said first capture areas and a plurality of second capture areas

The at least one image capturing device may be configured to capture an image associated with second capture area, wherein said image comprises a resolution sufficient for determining, within a predetermined threshold, a position of a fiducial on a substrate positioned at a corresponding said focusing plane.

The at least one image capturing device may be configured to capture an image associated with first capture area, wherein said image comprises a resolution sufficient for enabling, within a predetermined threshold, inspection of a printed pattern on a substrate positioned at a corresponding said focusing plane.

The optical system may comprise a first said image capturing device and a second said image capturing device configured for focusing with respect to a common said focusing plane, wherein said first image capturing device and said second image capturing device are configured for capturing images at a first field of view and at a second field of view, respectively, wherein said first field of view is larger than said second field of view.

In one embodiment of the optical system, the image processing device is configured for selectively masking images captured by a said image capturing device to provide image data corresponding to a first capture area that is smaller than a second capture area corresponding to image data provided from corresponding unmasked images captured by said image capturing device.

In another embodiment of the optical system, the at least one image capturing device comprises an optical zoom module having at least two settings, including a low zoom setting and a high zoom setting, wherein at said low zoom setting, said image capturing device is focused on and enables capture of a first capture area on a said focusing plane at a relatively large field of view, and wherein at said high zoom setting, said image capturing device is focused on and enables capture of a second capture area on the same said focusing plane at a relatively small field of view, and wherein said first capture area is dimensionally larger than said second capture area.

In another embodiment of the optical system, the said at least one image capturing device comprises an optical variable focusing module having at least two settings, a near focus setting and a far focus setting, wherein at said far focus setting, said image capturing device is focused on and enables capture of a first capture area on a first said focusing plane, and wherein at said near focus setting, said image capturing device is focused on and enables capture of a second capture area on a second said focusing plane, wherein said first focusing plane is further displaced from said image capturing device than said second focusing plane, and wherein said first capture area is dimensionally larger than said second capture area.

According to another aspect of the invention, a printing apparatus for printing a substrate is provided, comprising

a frame;

a stencil support, adapted for mounting thereto a stencil;

a support for supporting the substrate at least during dispensing of said material thereon;

wherein said apparatus is configured for providing reversible relative movement between said stencil holder and said support at least from a mutually superposed position to a mutually non-superposed position; and

an optical system coupled to said frame, said optical system comprising:

at least one image capturing device and an image processing device for processing images captured by the or each said image capturing device to selectively provide image data of said substrate and of a said stencil when held by said stencil holder;

a positioning mechanism for positioning the or each said image capturing device into optical alignment with respect to at least one position on at least one focusing plane associated with the printing apparatus to enable images to be captured thereat;

wherein the optical system is adapted for providing said image data corresponding to at least two capture areas of substantially different dimensions on said at least one focusing plane.

The printing apparatus may further comprise a stencil mounted to said stencil holder, said stencil comprising at least one aperture, and further comprising a dispensing system configured for dispensing a printing material onto said substrate via said at least one stencil aperture at a printing position.

The printing apparatus may further comprise a displacement mechanism for displacing said stencil holder between said superposed position and said non-superposed position, wherein at least in said superposed position, said stencil is at a said focusing plane of said optical system.

The printing apparatus may further comprise a cleaning system for removing printing material from said stencil as said stencil is displaced from said superposed position to said non-superposed position.

The printing apparatus may further comprise a feeding system for selectively feeding substrates to and delivering substrates from said support.

The stencil may be positioned at a first position and said substrate is positioned at a second position abutting said stencil at least during said dispensing, and further comprising a drive mechanism configured for reversibly and selectively placing the substrate at any one of said first position and said second position, wherein in said first position, said substrate is at a said focusing plane of said optical system.

Optionally, the at least two capture areas may include a first capture area and a second capture area, wherein said first capture area is dimensionally larger than said second capture area. The positioning mechanism may be configured for translating said at least one image capturing device along a plane substantially orthogonal to a viewing direction thereof, and for enabling said at least one image capturing device to become optically aligned with and capture images of a plurality of positions on said at least one focusing plane to selectively provide a plurality of said first capture areas and a plurality of second capture areas. The printing apparatus may be configured for selectively providing a plurality of said second capture areas on one or another of said substrate and on said stencil, when said substrate or said stencil, respectively, occupy a first position with respect to said at least one image capturing device, wherein in said first position, said substrate or said stencil, respectively, is at a said focusing plane of said optical system. Optionally, the plurality of second capture areas comprise fiducials on a corresponding one of said substrate and said stencil.

The printing apparatus may further comprise a controller for analyzing image data corresponding to fiducials on said substrate and said stencil and for controlling said mutual superposed positioning thereof.

At least one image capturing device may be configured to capture an image associated with second capture area, wherein said image comprises a resolution sufficient for determining a position, within a predetermined threshold, of a fiducial on a substrate positioned at a corresponding said focusing plane.

Optionally, the first position corresponds to said printing position of said stencil with respect to said frame.

The printing apparatus may be configured for selectively providing a plurality of said first capture areas on said substrate when said substrate occupies a second position with respect to said at least one image capturing device. The plurality of first capture areas may comprise areas on said substrate wherein said printing material has been deposited via said at least one stencil aperture. The second position may correspond to said printing position of said stencil with respect to said frame. The first position may be aligned along a viewing direction of said at least one image capturing device, and said first position may be further distanced therefrom than said printing position of said stencil. At least one image capturing device may be configured to capture an image associated with first capture area, wherein said image comprises a resolution sufficient for enabling inspection, within a predetermined threshold, of a printed pattern on a substrate positioned at a corresponding said focusing plane.

In one embodiment, the printing apparatus comprises a first said image capturing device and a second said image capturing device configured for focusing with respect to a common said focusing plane, wherein said first image capturing device and said second image capturing device are configured for capturing images at a first field of view and at a second field of view, respectively, wherein said first field of view is larger than said second field of view.

In another embodiment, the image processing device is configured for selectively masking images captured by a said image capturing device to provide image data corresponding to a first capture area that is smaller than a second capture area corresponding to image data provided from corresponding unmasked images captured by said image capturing device.

In another embodiment, the at least one image capturing device comprises an optical zoom module having at least two settings, low zoom and high zoom, wherein at said low zoom, said image capturing device is focused on and enables capture of a first capture area on a said focusing plane at a relatively large field of view, and wherein at high zoom, said image capturing device is focused on and enables capture of a second capture area on the same said focusing plane at a relatively small field of view, and wherein said first capture area is dimensionally larger than said second capture area.

In another embodiment, the at least one image capturing device comprises an optical variable focusing module having at least two settings, a near focus setting and a far focus setting, wherein at said far focus setting, said image capturing device is focused on and enables capture of a first capture area on a first said focusing plane, and wherein at said near focus setting, said image capturing device is focused on and enables capture of a second capture area on a second said focusing plane, wherein said first focusing plane is further displaced from said image capturing device than said second focusing plane, and wherein said first capture area is dimensionally larger than said second capture area.

According to another aspect of the invention, an optical system for use with printers and the like is provided, comprising:

at least one image capturing device and an image processing device for processing images captured by the or each said image capturing device to provide image data, wherein the optical system is adapted for providing said image data corresponding to at least two capture areas of substantially different dimensions on a common or different said focusing plane of said optical system.

The optical system according to this aspect of the invention comprises all the features and elements as disclosed above for the other aspects of the invention, mutatis mutandis.

According to another aspect of the invention, a method is provided for printing a material on a substrate via a stencil, comprising:

(a) performing an alignment procedure between a stencil and the substrate based on first image data corresponding to at least one first capture area of each one of said stencil and said substrate, prior to printing the material on the substrate; and

(b) performing an inspection procedure on the printed substrate based on second image data corresponding to at least one second capture area of said substrate;

wherein said at least one first and second capture areas are of substantially different dimensions one from the other.

Optionally, the resolution of the image data relating to the second capture area may be greater than the resolution of the image data relating to the first capture area.

Optionally, the first image data and said second image data may be obtained along a common viewing direction.

Optionally, the second capture area may be dimensionally larger than said first capture area, and wherein image data is provided for a plurality of said first capture areas and a plurality of second capture areas.

The method may further comprise selectively providing a plurality of said first capture areas on one or another of said substrate and on said stencil, when said substrate and said stencil, respectively, alternately occupy a first spatial position. The plurality of first capture areas may comprise fiducials on a corresponding one of said substrate and said stencil.

Step (a) may comprise analyzing image data corresponding to said fiducials on said substrate and said stencil, and mutually aligning said stencil and said substrate based on said analysis.

The method may comprise selectively providing a plurality of said second capture areas on said substrate when said substrate occupies a second spatial position.

Step (b) may comprise analyzing said plurality of second capture areas on said substrate wherein said printing material has been deposited via said stencil.

The first position may correspond to a printing position of said stencil. The second position may be displaced form a printing position of said stencil.

In one embodiment, the first image data may be based on at least one image captured at a first field of view and said second image data is based on at least one image captured at a second field of view, wherein said second field of view is larger than said first field of view.

In another embodiment, the first image data is based on at least one image captured at a first field of view and selectively masked to reduce the image size to provide said image data corresponding to said first capture area, and wherein said second image data is based on at least one image captured at said first field of view to provide said image data corresponding to said second capture area, wherein said first capture area is smaller than said second capture area.

In another embodiment, the first image data and said second image data are respectively obtained by optically zooming in or out, respectively, from a fixed image capturing position with respect to a focusing plane spatially fixed in relation thereto.

In another embodiment, the first image data is obtained at a first focusing plane at a first distance from a fixed image capturing position, and said second image data is obtained at a second focusing plane at a second distance from said fixed image capturing position, wherein said second distance is greater than said first distance.

According to another aspect of the invention, a method is provided for inspecting a printed substrate, previously printed at a substrate print position via a stencil located at a stencil print position at least during printing of said substrate, comprising:

inspecting the substrate from an inspection position generally superposed over said substrate print position, such that said inspection position is spaced from the substrate at a spacing not less than a spacing between the stencil print position and the substrate.

The step of inspecting said substrate may be carried out with said substrate located at any one of said substrate printing position, said stencil printing position, or a position below said substrate printing position.

According to another aspect of the invention, a method is provided for inspecting a printed substrate, previously printed at a substrate print position via a stencil located at a stencil print position at least during printing of said substrate, comprising:

inspecting the substrate from an inspection position generally superposed over and vertically aligned with said stencil print position.

The step of inspecting said substrate may be carried out with said substrate located at any one of said substrate printing position, said stencil printing position, or a position below said substrate printing position.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a plan view of a printing apparatus according to one embodiment of the invention.

FIG. 2 is a partial side view of the embodiment of FIG. 1.

FIG. 3 is a partial plan view of an optical system for use with a printing apparatus, according to a first embodiment of the invention.

FIG. 4 is a partial front view of the embodiment of FIG. 3.

FIG. 5 is a partial side view of the embodiment of FIG. 3.

FIG. 6 is a partial side view of an optical system for use with a printing apparatus, according to a second embodiment of the invention.

FIG. 7 is a top view of images areas captured with the embodiment of FIG. 6

FIG. 8 is a partial side view of an optical system for use with a printing apparatus, according to a third embodiment of the invention.

FIG. 9 is a partial side view of an optical system for use with a printing apparatus, according to a variation of the embodiment of FIG. 8.

### DETAILED DESCRIPTION OF EMBODIMENTS

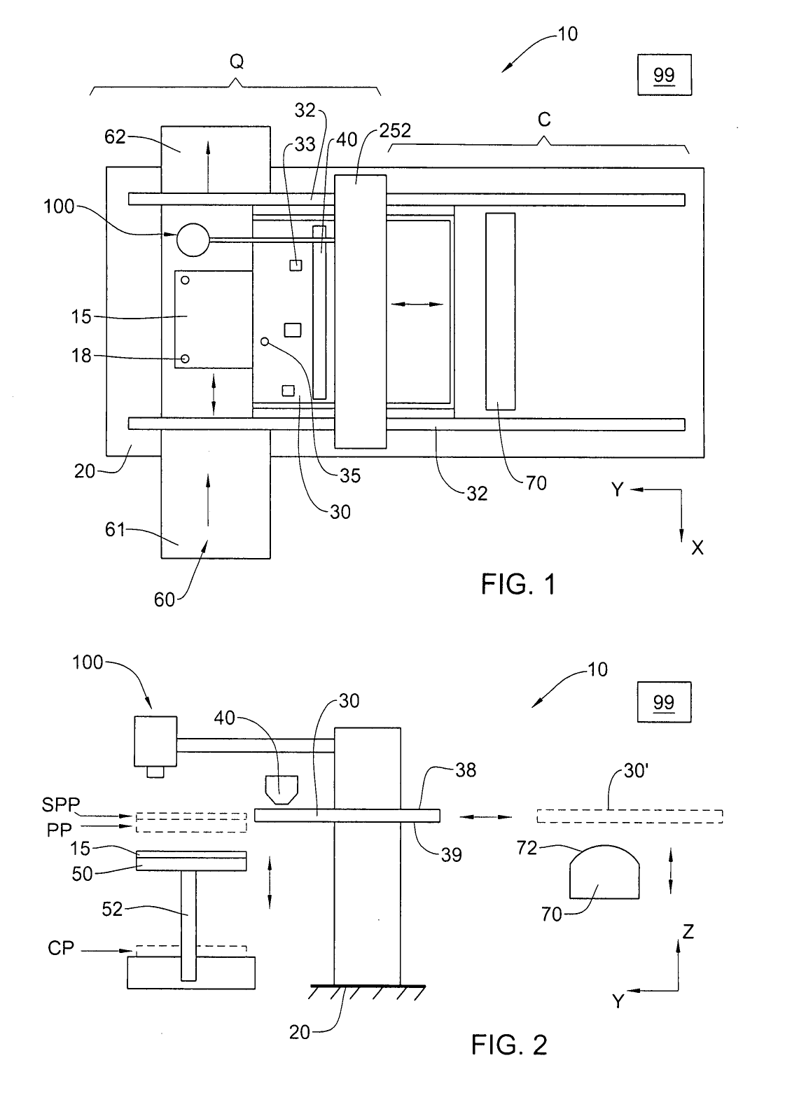

Referring to FIGS. 1 and 2 and in accordance with one aspect of the invention, a printing apparatus, generally designated with the reference numeral 10, comprises a frame 20, stencil 30, a solder dispensing system 40 for dispensing solder onto a substrate or board 15, and an optical system 100. It is convenient to define mutually orthogonal axes X, Y, Z for the apparatus 10 as follows: a longitudinal axis Y, a transverse axis X and a third axis Z, which is commonly set as vertical.

The board 15, used in conjunction with apparatus 10 may comprise any suitable electronic substrate or the like, onto which it is desired to print with an electrical conductor such as solder paste, for example. Alternatively, the board 15 may be used for non-electronic or non-electrical applications, for example for other types of screen printing, as is known in the art, wherein the substrate may be non-electronic. The board 15 comprises at least one fiducial 18 (or other optical markers, mutatis mutandis), and typically a number of fiducials 18 are provided, spaced from one another over the upper surface of the board 15.

The stencil 30 typically comprises a sheet construction, having a relatively flat upper surface 38 and lower face 39, and also comprises a plurality of apertures 33, corresponding to the pattern that it is wished to have printed onto the upper surface of board 15, and one or more markers or fiducials 35, typically a plurality of fiducials 35 that are spaced from one another over the upper surface 38 of the stencil 30, and that will aid in the alignment operations of the apparatus, as will become clearer herein.

The apparatus 10 may be divided into two general zones: a printing/inspection zone Q, and a cleaning zone C, which are arranged serially along the longitudinal axis Y of the apparatus 10. The stencil 30 is mounted to a stencil holder 31, which is mounted to a reciprocation mechanism including for example longitudinal parallel rails 32, configured for selectively enabling reversible displacement of the stencil 30 between the printing/inspection zone Q and cleaning zone C. The stencil displacement provided by the stencil displacement mechanism comprises, in this embodiment, a to-and-fro translation along the direction of longitudinal axis Y, over a plane substantially parallel to the X-Y plane. A suitable powered drive may be provided for driving the stencil between the two zones; alternatively, the stencil may be manually moved between the zones. In other embodiments, the displacement of the stencil 30 between the printing/inspection zone Q and cleaning zone C, and the relative dispositions of these zones with respect to the apparatus may be different. For example, the stencil may be translated along a suitably inclined plane, and/or rotated along one or more of the axes X, Y, Z, such as to reversibly move between the printing/inspection zone Q and cleaning zone C. The stencil holder 31 may be configured for enabling any one of a variety of stencils 30 to be reversibly mounted thereto, as desired by the user, and thus the apparatus only strictly requires a stencil 30 to be mounted thereto during printing operations, but may optionally be removed during inspection operations.

In yet other embodiments of the apparatus according to the invention, the stencil may be statically mounted to the frame, and the board is moved between a superposed and a non-superposed position with respect to the stencil. In such an embodiment, a suitable displacement mechanism is provided for the support.

A feed mechanism 60 may optionally be provided for automatically feeding one board 15 at a time, first towards and subsequently away from a board support 50, which may be positioned generally at the center of a printing/inspection zone Q or proximate thereto, for example. The feed mechanism 60 may comprise for example a conveyor system or the like, for example including an inlet conveyor 61 and an outlet conveyor 62, both being aligned generally parallel to a transverse axis X of the apparatus 10, for feeding a board to the support 50 for subsequent printing and inspection operations, and for delivering the board 15 from the support 50 at the end of such operations, respectively. The inlet conveyor 61 receives one board at a time from a stack (not shown) under control of controller 99, and outlet conveyor 62 delivers printed boards 15 to a post processing means (not shown), for example a packaging facility. While the conveyors 61, 62 are illustrated in FIG. 1 as translating the board 15 to and from the support 50 along the negative X direction, the may instead be configured to translate the boards in the positive X-direction, or indeed along any other suitable direction, the apparatus 10 being suitably configured to allow this. Alternatively, instead of two conveyors, one conveyor may be used both to feed the boards 15 to the support 50 and to deliver therefrom in generally opposed directions, the conveyor being suitably arranged with respect to the support 50. Alternatively, rather than using a feed mechanism, the boards 15 may be loaded and unloaded manually with respect to the support 50.

The support 50 comprises a board nest for receiving and accommodating a board 15, and for transporting the board during the alignment, printing and inspection operations of the apparatus 10. The support 50 is mounted onto a suitable elevator arrangement 52, which displaces the support 50 and board 15 between a number of positions along the Z-axis, i.e., vertical positions, including in some embodiments all of: a lowermost, conveyor position CP, which is vertically generally aligned with the conveyor system 60 to facilitate feeding and delivery operation thereof; a board printing position, PP, which is where the board 15 is fixedly held while being printed; and the stencil printing position, SPP (when the stencil is removed from this position), the SPP being the position of the stencil 30 when printing of the board 15 is being carried out. The support 50 also comprises micro-movement mechanisms (not shown) for controllably adjusting the position of the board with respect to the support, with respect to one, two or three orthogonal axes X, Y or Z, and are operatively connected to controller 99. Such controlled adjustments may be performed during alignment operations of the apparatus 10, as will be described in greater detail hereinbelow.

The solder dispensing system 40 comprises any suitable means for dispensing solder onto a board 15 when this and the stencil are at their respective print positions, PP and SPP. The solder dispensing system comprises at least one wiper, squeegee or other suitable spreader device, configured for traversing upper surface 38 of the stencil 30 and spreading solder paste or the like, this having been previously deposited onto surface 38. Solder paste or the like may be delivered manually to the stencil surface 38, or alternatively via suitable solder reservoirs (not shown), operation of which may be controlled via controller 99. Particularly in embodiments in which the solder paste is spread manually, the solder dispensing system 40 may be independent of the apparatus 10, and thus does not form an integral part of the same, though nevertheless used therewith when the apparatus 10 is in printing operation.

The apparatus further comprises a stencil cleaning system 70, configured for cleaning the lower surface 39 of the stencil 30 from residues of paste or whatever other material is being printed onto the board, after one or a number of printing cycles. The stencil cleaning system 70 comprises a cleaning head 72 which may comprise one or more of: a wiper, cleaning paper or cloth or other material, or a suction means, for cleaning the surface 39 as the stencil is translated over the head 72. In this embodiment, the cleaning head 72 is statically mounted within the cleaning zone C, and positioned such that by the time the stencil 30 is fully translated away from the SPP, cleaning operations with respect to the stencil may be completed. Thus, the cleaning head 72 may be positioned transversely close to the printing/inspection zone Q.

Alternatively, the cleaning head 72 may be translated and/or rotated (for example about an axis parallel to the Z-axis) within the cleaning zone C to add to the relative movement between the head and stencil 30 as the latter is translated from the SPP to the cleaning zone C.

The optical system 100 is configured for enabling alignment between the stencil 30 and the unprinted board 15, for example before printing and also for enabling inspection of the board 15, for example after printing.

The optical system 100 comprises one or more image acquisition or capturing devices, mounted onto a suitable positioning mechanism, enabling the devices to be deployed and operate from positions above those adopted by the stencil and by the board during at least alignment and inspection operations of the apparatus 10.

In particular, and as will be described in greater detail herein, the optical system 100 provides, optically and/or digitally, image data corresponding to one or a plurality of relatively small capture areas, in some embodiments each corresponding to a relatively narrow field of view (FOV), for alignment operations, and also image data corresponding to one or a plurality of relatively large capture areas, in some embodiments each corresponding to a relatively large FOV, for inspection operations. The image capturing directions of the system 100 for obtaining the image data for the small and large capture areas are substantially co-directional, and are in some embodiments also co-aligned. A number of embodiments of the optical system 100 will be described in further detail herein, after a brief description of the general operation of the apparatus 10.

Operation of the printing apparatus 10 generally comprises at least some of the following steps:—

(a) Alignment between the stencil 30 and the board 15.

(b) Printing.

(c) Separating the printed board.

(d) Cleaning the stencil.

(e) Inspecting the printed board.

Step (a) is preceded by placement of a board 15 onto the support 50, which may be accomplished manually or via the conveyor system 60, for example. In step (a), the stencil 30 and unprinted board 15 are aligned to ensure that the stencil apertures 33 are properly superposed over the desired areas of the board 15 during printing. With the stencil at the SPP, the optical system 100 moves the image capture device (via the corresponding positioning mechanism) so as to align its optical axis with the expected position each of the fiducials 35 in turn, and provides image data corresponding to each of the fiducials 35 (or other optical markers that may be provided on the stencil 30, mutatis mutandis) on the stencil 30 via the capability of the image capture device of the system 100 to capture images corresponding to relatively small capture areas. The controller 99 processes the data to determine the spatial position of each of the fiducials 35. The stencil 30 is retracted to the cleaning zone C, optically exposing the board 15 to the optical system 100.

The board 15 is raised to the SPP position recently vacated by the stencil 30, and the optical system 100 provides image data corresponding to each of the fiducials 18 (or other optical markers, mutatis mutandis) on the board 15, by moving the image capture device each time using the corresponding positioning mechanism, also via the aforesaid capability of the image capture device of the system 100 to capture images corresponding to relatively small capture areas. Controller 99 processes the data to determine the spatial position of each of the fiducials 18. The controller 99 then computes the difference between the spatial positions of each set of corresponding fiducials 18 and fiducials 35, and determines the adjustment in position of the board 15 with respect to support 50 that is required, if any, in order to eliminate these differences or to bring these differences to within an acceptable threshold or tolerance. Suitable command signals are then generated and transmitted to the micro-movement mechanisms of support 50, which then adjust the position of the board 15 in an appropriate manner. The board 15 is lowered from the SPP position, either before, during or after such adjustment, to allow the stencil 30 to be re-deployed to the SPP position, and the board 15 is then moved to its print position PP, with an upper surface of the board in abutting contact with lower surface 39 of the stencil 30, and aligned therewith.

In embodiments of the printing apparatus where the stencil is static the board is instead retracted away from a position below the stencil and raised into alignment with the plane of the stencil, and the optical system moves the image capturing device(s) from a position over the stencil to obtain image data of its fiducials there, to a position over the raised board to obtain image data of its fiducials.

In step (b), having aligned and overlaid the stencil with respect to the unprinted board 15, solder paste or another suitable adhesive is deposited on the upper side 38 of the stencil, and a squeegee or wiper blade of solder dispensing system 40 is passed over the stencil upper surface 38, forcing solder paste into the stencil apertures 33 and thus onto the board.

The printed board 15 is then separated from the stencil 30 (step (c)); while most of the solder paste is deposited on the board, it may be necessary or desired from time to time, or after every print cycle, to clean the stencil 30 (step (d)) from solder paste residues before the next printing cycle.

In step (e), the board is inspected after printing to determine the quality of the print. Inspection is carried out using the capability of the image capture device of the system 100 to capture images corresponding to relatively large capture areas, which enables good quality images of relatively large areas of the board 15 to be obtained with each scan, providing fast inspection, and enabling the next board 15 to be fed to the support 50 relatively quickly. The image capturing device that is used for inspection is thus moved with respect to the board 15 via the drive mechanism enabling a number of consecutive scans of different areas of the board to be taken, and the image data obtained with these scans may be stitched together to form a composite image of the printed board or part thereof. The image thus obtained may then be analysed to identify whether the print is within an acceptable standard, as is known in the art.

Depending on the relative sizes of the board 15 and stencil 30, it may be possible to commence inspection while the stencil is still being retracted into zone C and optionally cleaned. Alternatively, inspection of the board 15 may commence after the stencil 30 is fully retracted into the cleaning zone C.

A number of embodiments of the optical system 100 will now be described, which is, according to another aspect of the invention, a novel per se optical system, and which may be applied for use with the printing apparatus of the present invention, or with other suitable printers, or the like, mutatis mutandis.

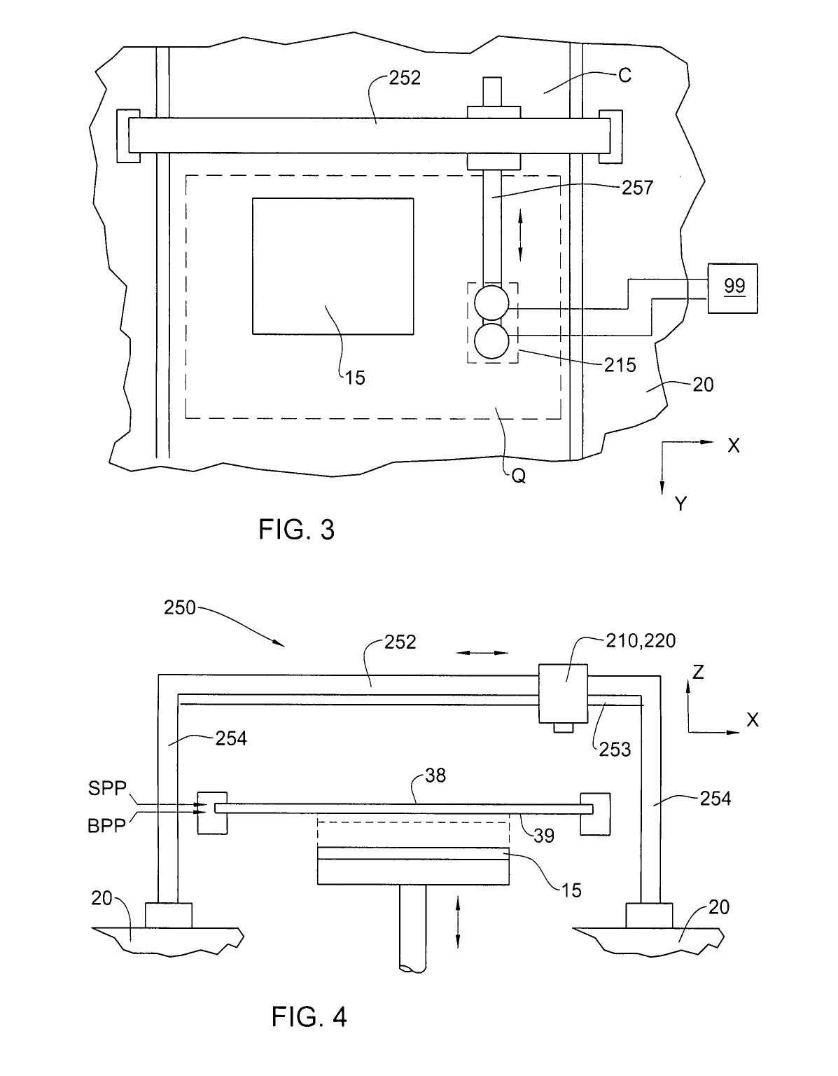

Referring to FIGS. 3, 4 and 5 the optical system according to a first embodiment of the invention is generally designated with the reference numeral 200, and comprises a first image capturing device 210 and a second image capturing device 220, each mounted to a common two-axis positioning mechanism 250. The first and second image capturing devices 210, 220 may each comprise any suitable video or digital camera, e.g., any CCD- or CMOS-based camera, which can transmit an image electronically to controller 99, which includes a microprocessor means such as a suitable computer, via an image grabber, for example. Thus, the first and second image capturing devices 210, 220 are capable of providing digital image data to controller 99, to which they are operatively connected to, for subsequent processing. While the first and second image capturing devices 210, 220 may provide image data from the visible spectrum, such data may alternatively be provided from the infra red or ultraviolet or other part of the spectrum.

In particular, first image capturing device 210 is adapted for focusing on and obtaining images at different positions on a plane parallel to the position adopted by the stencil during printing operations, in particular the upper surface 38 thereof, herein referred to as stencil print position SPP. The first image capturing device 210 separately captures images of the board 15 and of the stencil 30 when these are alternately located at the SPP, the images being associated with a relatively narrow FOV, designated FOV₁. In particular, an image is taken of each one or more areas of the fiducial-containing areas of stencil at position SPP, and then the stencil is displaced horizontally away from this position. The board 15 is moved to the position SPP, where one or more images corresponding to the fiducial-containing parts of the board are taken. FOV₁ is such as to enable each individual fiducials or other individual visual alignment markers on the board 15 and stencil 30 to be fully captured in turn from the position of the first image capturing device 210 vertically displaced therefrom. Such fiducials or markers may commonly occupy a capture area of between about 60 mm² to about 120 mm², and with the first image capturing device 210 being vertically spaced from the printing position between about 20 cm and about 40 cm, the FOV, may be between about 4 degrees to about 6 degrees (full cone angle). Concurrently, the resolution of the first image capturing device 210 is at least sufficient such as to ensure that the images captured thereby of the fiducials 18 and 35 are of a sufficient quality to enable accurate alignment calculations to be made based thereon. Image resolutions may range between about 6 micron and about 18 micron. Examples of suitable cameras and lens systems for first image capturing device 210 may include, by way of non-limiting example, BDR Technologies Model: BCMU1300M/C-M, (Israel). The first image capturing device 210 may be adapted for capturing color images of the board 15 or stencil 30. However, when adapted for capturing monochromatic images, improved accuracy may sometimes be obtained with respect to a comparable color-based device.

According to another aspect of the invention, the image capturing operation by first image capturing device 210 may occur at a different position to that of the stencil print position SPP. In such a case, the printing apparatus 10 is configured for enabling the stencil 30 and/or the board 15 to be alternately moved to that position.

On the other hand, the second image capturing device 220 is adapted for focusing on and capturing an image of a relatively larger part of the board 15 at a plane corresponding to an inspection position, at a relatively broad FOV, designated FOV₂ for inspection purposes. Thus, FOV₂ is of a magnitude such as to enable relatively large portions of the printed board 15 to be sequentially captured from the position of the second image capturing device 220, which is vertically displaced therefrom. The size of the board capture area A of interest may vary between different applications of the invention, and may be set such that a particular area of interest of the board 15, which in some cases may include the full upper-facing surface of the printed board 15, may be fully scanned with a minimum number of individual image captures. Thus, by way of example, the capture area A may comprise between about 2000 square mm to about 9000 square mm, and With the second image capturing device 220 also being vertically spaced from the printing position between about 20 cm and about 40 cm, the FOV₂ may be between about 8 degrees to about 14 degrees (full cone angle). Concurrently, the resolution of the second image capturing device 220 is at least sufficient such as to ensure that the images captured thereby of the solder printed thereon are of a quality to enable accurate measurement thereof, in particular to enable quality control calculations of solder application to be made based thereon. Image resolutions may optionally be less than for the first image capturing device 210, and in any case may range between about 20 micron and about 30 micron. Examples of suitable cameras and lens systems for second image capturing device 220 may include, by way of non-limiting example, LUMENERA Model LW620 (Canada). The second image capturing device 220 may be adapted for capturing color or monochromatic images of the board 15.

According to one aspect of the invention, the inspection position is at the print position PP of the board 15.

According to another aspect of the invention, the inspection position is at the stencil print position SPP, and thus the board 15 is moved to this position after printing, for the inspection operations.

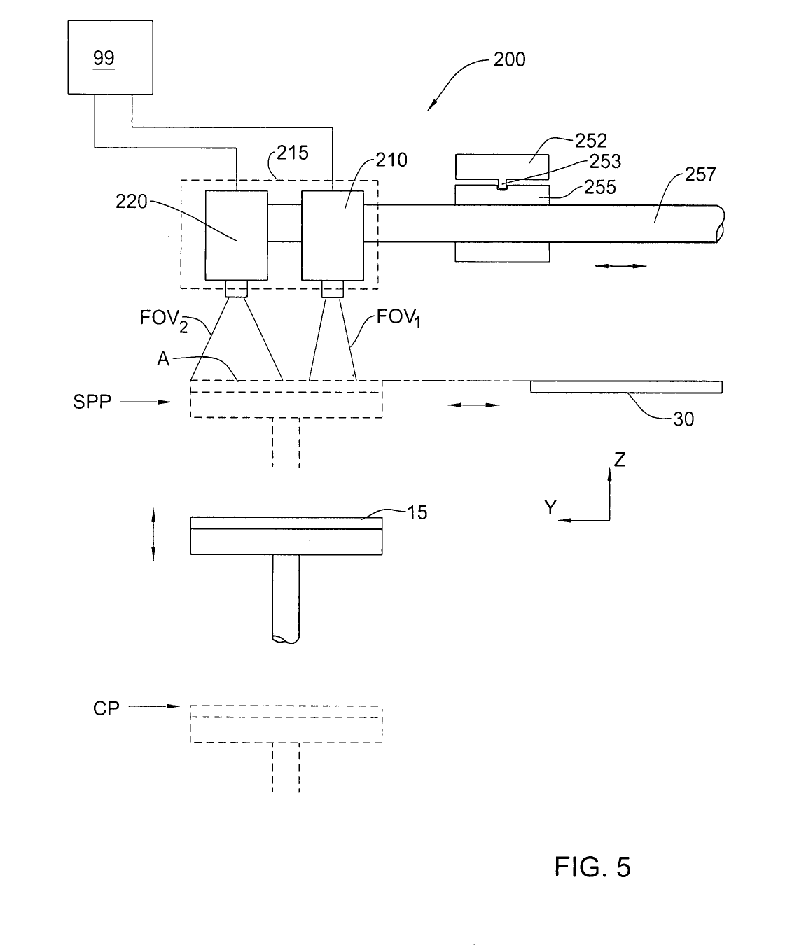

According to another aspect of the invention, the inspection position is at a position vertically displaced below the print position of the board 15, and thus the board 15 is moved to this position after printing for the inspection operations. The inspection position may be variably set by the user wherever desired, for example by means of the elevator arrangement 52, and may include, for example, the conveyor position CP directly below the SPP for example (FIG. 5). In such an embodiment, the first and second image capturing devices 210, 220 are facing the same direction, and are focused on different planes, at SPP and CP, respectively. Further, the increased distance between the second image capturing device 220 and the board 15, as compared with where the inspection position is at the SPP, allows a much larger portion of the board 15 to be inspected for the same angular FOV; accordingly, inspection of the board can be completed at a correspondingly faster rate. In a variation of this embodiment, the inspection position may be at a position vertically lower than the CP, and for this purpose the elevator arrangement 52 may be further configured for enabling the board 15 to be reversibly moved to a position vertically below the CP.

The first image capturing device 210 and second image capturing device 220 may be configured to be included in a common housing or camera head 215, which is itself mounted to the drive mechanism 250.

Referring in particular to FIG. 5, the positioning mechanism 250 is configured for transporting the first image capturing device 210 and second image capturing device 220 over the printing/inspection zone Q, so as to enable the optical axes of the devices to be selectively aligned with each of the various fiducials on the stencil and board, as well as the printed zones on the latter. The positioning mechanism 250 comprises a static support beam or strut 252 that carries a rail 253 that is aligned along the X-axis, the strut being supported at a position vertically displaced from the print position via support columns 254, or any other suitable supports, which are mounted onto the frame 20. As will be better understood herein, the vertical spacing between the strut 252 and the stencil print position SPP is at least sufficient to enable the first image capturing device 210 and second image capturing device 220 to be moved along a horizontal plane over the image capture areas above the board 15, without interfering with operation of other components of the print apparatus 10, in particular the stencil 30 and/or the solder dispensing system 40. In the illustrated embodiment, the strut 252 is located generally intermediate between the cleaning zone C and the print/inspection zone Q. In other embodiments though, the strut 252 may be located anywhere over the print/inspection zone Q or at a different part of the periphery thereof, or at a different part of the apparatus 10.

A displacement mechanism in the form of shuttle 255 is mounted to the rail 253 for enabling relative translation with respect thereto parallel to axis X, i.e., to enable displacement of the shuttle 255 along the positive and negative X-directions. For example, the shuttle 255 and rail 253 may comprise a linear motor arrangement, or indeed any other suitable drive mechanism may be provided for enabling relative movement between the shuttle 255 and rail 253. The shuttle 255 carries a horizontal rail 257 statically mounted thereto, and that is aligned parallel to the Y-axis; thus the rail 257 is carried with shuttle 255 when the latter is displaced along the X-axis. The rail 257 extends over the print/inspection zone Q.

The camera head 215 is mounted to rail 257 for relative translation with respect thereto parallel to axis Y, i.e., to enable displacement of the camera head 215 along the positive and negative Y-directions. By way of non-limiting example, the camera head 215 and rail 257 may comprise a linear motor arrangement, or indeed any other suitable drive mechanism may be provided for enabling relative movement between the camera head 215 and rail 257.

Alternatively, the rail 257 is slidingly mounted with respect to the shuttle 255 for relative movement therewith along the Y-axis, and the camera head is statically mounted to the rail 257. By way of non-limiting example, the shuttle 255 and rail 257 may then comprise a linear motor arrangement, or indeed any other suitable drive mechanism may be provided for enabling relative movement between the shuttle 255 and rail 257.

Thus, by appropriately controlling the movement of the shuttle 255 with respect to rail 253 along the X-axis, and the movement of the camera head 215 with respect to rail 257 along the Y-axis, by means of controller 99, the camera head can be positioned substantially anywhere along an X-Y plane above the printing/inspection zone Q.

Alternatively, rather than having both the first image capturing device 210 and second image capturing device 220 mounted in a common camera head 215, they may be separately mounted to the rail 257 for independent movement with respect thereto. Alternatively, the positioning mechanism 250 may be configured for allowing complete independent movement of each of the two image capturing devices 210, 220. For example, each may be mounted to a separate static strut in a similar manner to that described above for the camera head 215, mutatis mutandis, or to the same strut but via different shuttles and corresponding rails. Alternatively, each image capturing device may be mounted to an independently controllable robotic arm, or alternatively to the same robotic arm if independent movement is not required.

Although in the illustrated embodiment, the image capturing devices are constrained to move only along the X and Y axes, in other embodiments the drive mechanism may be configured also to provide displacement along the Z axis.

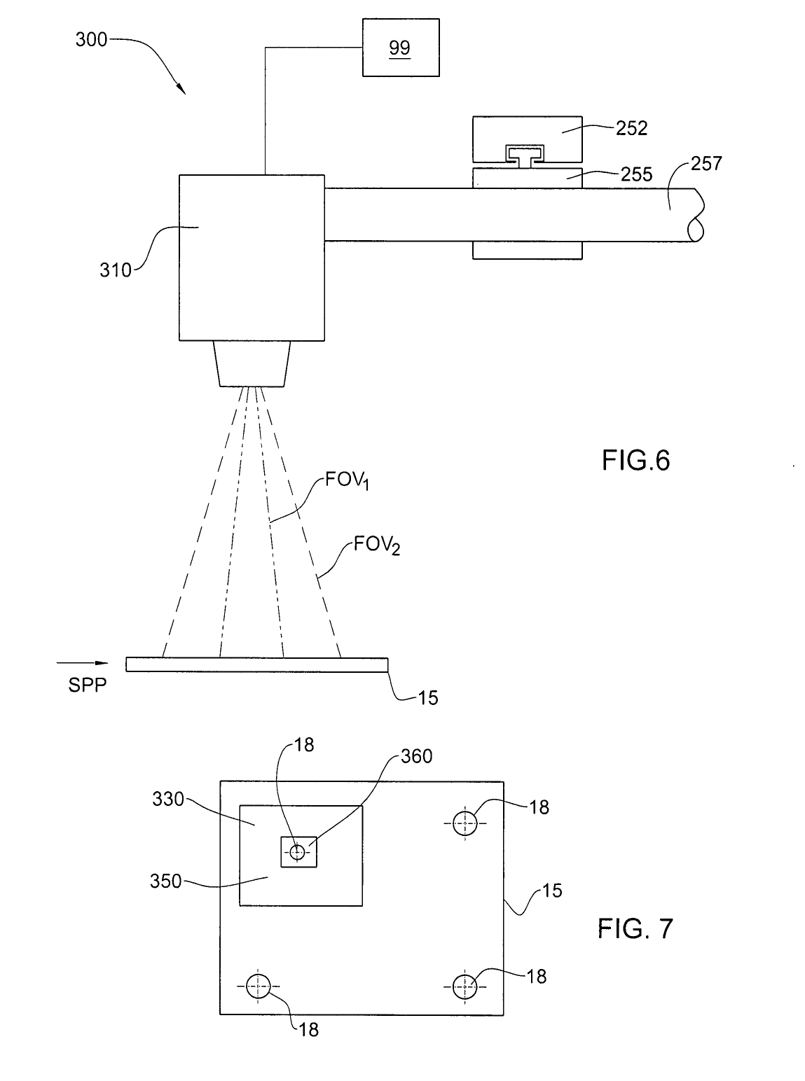

Referring to FIGS. 6 and 7, the optical system according to a second embodiment is generally designated with the reference numeral 300, and comprises an image capturing device 310 mounted to a positioning mechanism, which may be similar to positioning mechanism 250 or variations thereof as described for the first embodiment, mutatis mutandis. The image capturing device 310 may comprise any suitable video or digital camera, e.g., any CCD- or CMOS-based camera, which can transmit an image electronically to controller 99, which includes a microprocessor means such as a suitable computer, via an image grabber, USB, firewall, and so on, for example. Thus, the image capturing devices 310 is capable of providing digital image data to controller 99, to which it is operatively connected to, for subsequent processing. While the image capturing device 310 may provide image data from the visible spectrum, such data may alternatively be provided from the infra red or ultraviolet or other part of the spectrum.

As with the first embodiment, the system 300 also provides image data relating to a narrow field of view FOV₁ when in alignment mode corresponding to relatively small capture areas, and also provides image data relating to a substantially wider field of view FOV₂ corresponding to relatively large capture areas when in inspection mode, though using only using a single image capturing device 310. In this embodiment, the stencil 30 and board 15 are each separately positioned at SPP, for alignment mode, and the board is subsequently positioned at SPP, after printing, for inspection mode. The image capturing device 310 is set to capture an image using an optically large field of view FOV₂ both, in alignment mode and in inspection mode. In the latter, the image obtained by the image capturing device 310 is processed by the controller 99 in a similar manner to that described for image capturing device 220 of the first embodiment mutatis mutandis. However, and referring to FIG. 7, in alignment mode, the controller 99 is adapted for automatically masking out a large part of the image obtained with the large field of view setting FOV₂. In the illustrated example of FIG. 7, image data 350 is obtained for one or more particular capture areas of the upper surface of the board 15 that is expected to contain a fiducial 18 or other alignment markings. The image data relating to remainder of the image data, for example relating to an outer periphery 330 of the image data 350 obtained by the image capturing device 310, is then masked, separated from, or deleted, or otherwise removed from the original image data leaving only a smaller part of the image data, referred to as the target image data 360, which should contain the image data relating to one or more of the fiducial 18 that is being viewed. The relative size of the each target image data 360 with respect to the size of the corresponding fiducial 18 in the image can be chosen so as to ensure that the fiducial 18 will be found in this part of the image, when the image capturing device 310 is moved to a location directly above the fiducial 18 such that the optical axis of the device 310 is aligned therewith. At the same time, removal of the unwanted data at periphery 330 of the image data considerably reduces the processing time that is required by controller 99 to process the image relating to the fiducial, and to subsequently compute the alignment operations that may be required for the board 15 relative to the stencil 30. Thus, while an optical image is obtained at a relatively large field of view FOV₂, corresponding to a larger capture area, the system 300 effectively provides, electronically or digitally, image data corresponding to a narrower field of view, FOV₁, corresponding to a smaller capture area, the image data being subsequently processed for alignment operations. Of course, the image capturing device 310 may be moved over the zone Q to enable images containing other fiducials as required, in a similar manner.

In inspection mode, the image capturing device 310 operates in a similar manner to that described for the second image capturing device 220, mutatis mutandis, the full image data 350 being used without masking.

In this embodiment, the resolution of the image capturing device 310, and the type of device, may be similar to that disclosed for the first image capturing device 210 of the first embodiment, mutatis mutandis.

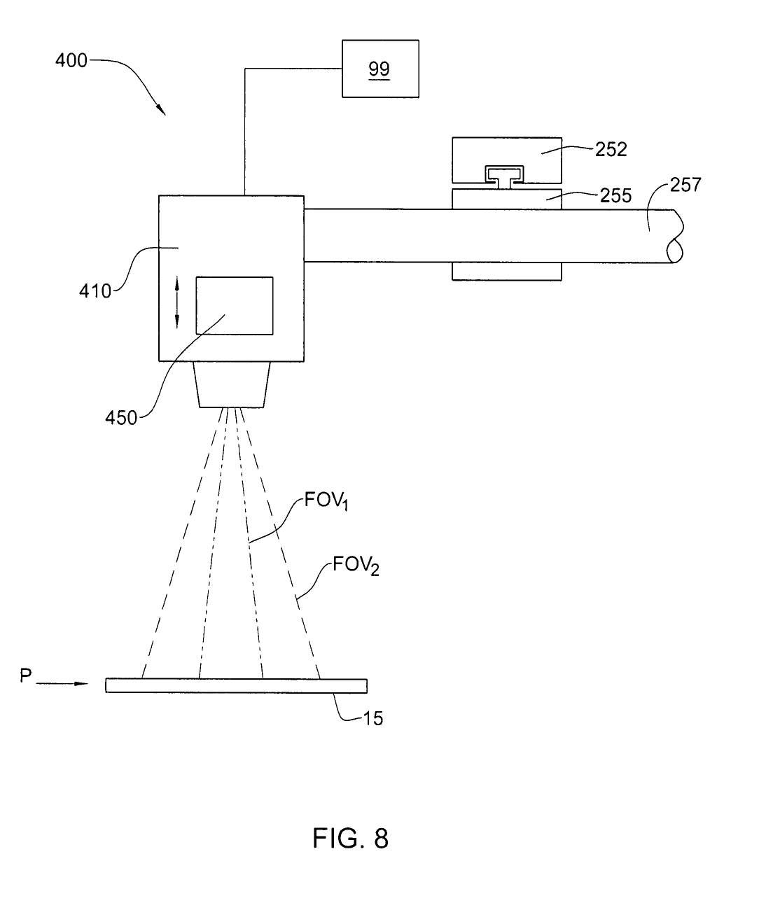

Referring to FIG. 8, the optical system according to a third embodiment of the invention is generally designated with the reference numeral 400, and comprises an image capturing device 410 mounted to a positioning mechanism, which may be similar to positioning mechanism 250 or variations thereof as described for the first or second embodiments, mutatis mutandis. The image capturing device 410 may comprise any suitable video or digital camera, e.g., any CCD- or CMOS-based camera, which can transmit an image electronically to controller 99, which includes a microprocessor means such as a suitable computer, via an image grabber, for example. Thus, the image capturing devices 410 is capable of providing digital image data to controller 99, to which it is operatively connected to, for subsequent processing. While the image capturing device 410 may provide image data from the visible spectrum, such data may alternatively be provided from the infra red or ultraviolet or other part of the spectrum.

As with the first and second embodiments, the system 400 provides image data relating to one or a plurality of relatively small capture areas corresponding to a narrow field of view FOV₁ when in alignment mode, and provides image data relating one or a plurality of relatively large capture areas corresponding to a substantially wider field of view FOV₂ when in inspection mode, though using only using a single image capturing device 410. In this embodiment, the stencil 30 and board 15 are each separately positioned at SPP, for alignment mode, and the board is subsequently positioned at SPP, after printing, for inspection mode.

In this embodiment, the image capturing device 410 comprises an optical zoom module with zoom capability, indicated at 450, having at least two settings, low zoom and high zoom. At low zoom, the image capturing device 410 is focused on and effectively acts to obtain an image of a relatively large capture area of the board 15 at the stencil print position SPP with a relatively large field of view FOV₂, enabling inspection of the board 15 as with the other embodiments, mutatis mutandis. At high zoom, and still focused at the position SPP, and the image capturing device effectively acts to obtain an image of a smaller, but enlarged, capture area of the board 15, i.e., with a relatively smaller field of view FOV₁, enabling alignment of the board 15 as with the other embodiments, mutatis mutandis. Thus, in this embodiment, higher resolution is obtained at the high zoom setting, and a relatively lower resolution at the low zoom setting.

In inspection mode, the image capturing device 410 operates in a similar manner to that described for the second image capturing device 220, mutatis mutandis.

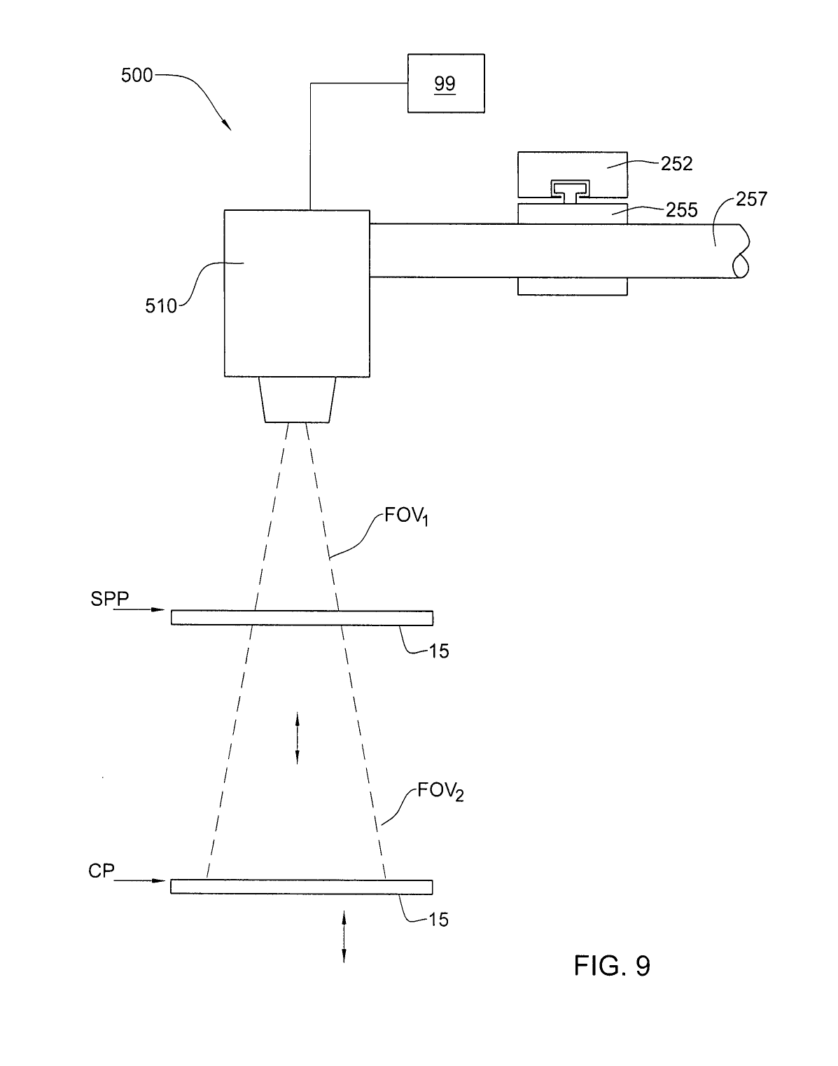

Referring to FIG. 9, the optical system according to a fourth embodiment of the invention is generally designated with the reference numeral 500, and comprises an image capturing device 510 mounted to a positioning mechanism, which may be similar to positioning mechanism 250 or variations thereof as described for the first or second embodiments, mutatis mutandis. The image capturing device 510 may be similar to that described for the third embodiment, mutatis mutandis. Thus, the image capturing device 510 is capable of providing digital image data to controller 99, to which it is operatively connected to, for subsequent processing.

As with the first, second and third embodiments, the system 500 provides image data relating to one or a plurality of relatively small capture areas corresponding to a narrow field of view FOV₁ when in alignment mode, and provides image data relating one or a plurality of relatively large capture areas corresponding to a substantially wider field of view FOV₂ when in inspection mode, though using only using a single image capturing device 510. In this embodiment, the stencil 30 and board 15 are each separately positioned at SPP.

The inspection position, however, may be set at a position vertically displaced below the print position of the board 15, and thus the board 15 is moved to this position after printing for the inspection operations. The inspection position may be variably set by the user wherever desired, for example by means of the elevator arrangement 52, and may include, for example, the conveyor position CP directly below the SPP for example. In such an embodiment, the device 510 is configured for focusing on and obtaining images at one of at least two vertically displaced planes: during inspection mode the image capturing device 510 is now focused on a plane at CP, while in the alignment mode it is focused at a plane of the SPP closer to the device 510. Thus, the image capturing device 510 comprises a variable focusing depth module, enabling planes at different distances from the device 510 to be brought into focus thereby. The increased distance between the image capturing device 510 and the board 15, as compared with where the inspection position is at the SPP, allows a much larger capture area of the board 15 to be inspected for the same angular FOV; accordingly, inspection of the board can be completed at a relatively fast rate. In a variation of this embodiment, the inspection position may be at a position vertically lower than the CP, and for this purpose the elevator arrangement 52 may be further configured for enabling the board 15 to be reversibly moved to a position vertically below the CP.

In a variation of the fourth embodiment, the image capturing device 510 also comprises a zoom capability, similar to that described for the third embodiment, mutatis mutandis, providing greater versatility in the operation thereof.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed example embodiments in accordance with the invention, it will be appreciated that many changes may be made therein without departing from the spirit of the invention.

1. An optical system for use with printers and the like, comprising:
at least one image capturing device and an image processing device for processing images captured by the or each said image capturing device to provide image data;
a positioning mechanism for positioning the or each said image capturing device into optical alignment with respect to at least one position on at least one focusing plane associated with the printer to enable images to be captured thereat;
wherein the optical system is adapted for providing said image data corresponding to at least two capture areas of substantially different dimensions on a same or different said at least one focusing plane.

2. An optical system according to claim 1, wherein said at least two capture areas includes a first capture area and a second capture area, wherein said first capture area is dimensionally larger than said second capture area.

3. An optical system according to claim 2, wherein said positioning mechanism is configured for translating said at least one image capturing device along a plane substantially orthogonal to a viewing direction thereof, and for enabling said at least one image capturing device to become optically aligned with and capture images of a plurality of positions on said at least one focusing plane to provide a plurality of said first capture areas and a plurality of second capture areas

4. An optical system according to claim 2, wherein said at least one image capturing device is configured to capture an image associated with second capture area, wherein said image comprises a resolution sufficient for determining, within a predetermined threshold, a position of a fiducial on a substrate positioned at a corresponding said focusing plane.

5. An optical system according to claim 2, wherein said at least one image capturing device is configured to capture an image associated with first capture area, wherein said image comprises a resolution sufficient for enabling, within a predetermined threshold, inspection of a printed pattern on a substrate positioned at a corresponding said focusing plane.

6. An optical system according to claim 1, comprising a first said image capturing device and a second said image capturing device configured for focusing with respect to a common said focusing plane, wherein said first image capturing device and said second image capturing device are configured for capturing images at a first field of view and at a second field of view, respectively, wherein said first field of view is larger than said second field of view.

7. An optical system according to claim 1, wherein said image processing device is configured for selectively masking images captured by a said image capturing device to provide image data corresponding to a first capture area that is smaller than a second capture area corresponding to image data provided from corresponding unmasked images captured by said image capturing device.

8. An optical system according to claim 1, wherein said at least one image capturing device comprises an optical zoom module having at least two settings, including a low zoom setting and a high zoom setting, wherein at said low zoom setting, said image capturing device is focused on and enables capture of a first capture area on a said focusing plane at a relatively large field of view, and wherein at said high zoom setting, said image capturing device is focused on and enables capture of a second capture area on the same said focusing plane at a relatively small field of view, and wherein said first capture area is dimensionally larger than said second capture area.

9. An optical system according to claim 1, wherein said at least one image capturing device comprises an optical variable focusing module having at least two settings, a near focus setting and a far focus setting, wherein at said far focus setting, said image capturing device is focused on and enables capture of a first capture area on a first said focusing plane, and wherein at said near focus setting, said image capturing device is focused on and enables capture of a second capture area on a second said focusing plane, wherein said first focusing plane is further displaced from said image capturing device than said second focusing plane, and wherein said first capture area is dimensionally larger than said second capture area.

10. An optical system according to claim 1, wherein a resolution of the image data relating to the second capture area may be greater than the resolution of the image data relating to the first capture area.

11. A printing apparatus for printing a substrate, comprising
a frame;
a stencil support, adapted for mounting thereto a stencil;
a support for supporting the substrate at least during dispensing of said material thereon;
wherein said apparatus is configured for providing reversible relative movement between said stencil holder and said support at least from a mutually superposed position to a mutually non-superposed position; and
an optical system coupled to said frame, said optical system comprising:
at least one image capturing device and an image processing device for processing images captured by the or each said image capturing device to selectively provide image data of said substrate and of a said stencil when held by said stencil holder;
a positioning mechanism for positioning the or each said image capturing device into optical alignment with respect to at least one position on at least one focusing plane associated with the printing apparatus to enable images to be captured thereat;
wherein the optical system is adapted for providing said image data corresponding to at least two capture areas of substantially different dimensions on said at least one focusing plane.

12. A printing apparatus according to claim 10, further comprising a stencil mounted to said stencil holder, said stencil comprising at least one aperture, and further comprising a dispensing system configured for dispensing a printing material onto said substrate via said at least one stencil aperture at a printing position.

13. A printing apparatus according to claim 12, further comprising a displacement mechanism for displacing said stencil holder between said superposed position and said non-superposed position, wherein at least in said superposed position, said stencil is at a said focusing plane of said optical system.

14. A printing apparatus according to claim 12, further comprising a cleaning system for removing printing material from said stencil as said stencil is displaced from said superposed position to said non-superposed position.

15. A printing apparatus according to claim 11, further comprising a feeding system for selectively feeding substrates to and delivering substrates from said support.

16. A printing apparatus according to claim 12, wherein said stencil is positioned at a first position and said substrate is positioned at a second position abutting said stencil at least during said dispensing, and further comprising a drive mechanism configured for reversibly and selectively placing the substrate at any one of said first position and said second position, wherein in said first position, said substrate is at a said focusing plane of said optical system.

17. A printing apparatus according to claim 12, wherein said at least two capture areas includes a first capture area and a second capture area, wherein said first capture area is dimensionally larger than said second capture area.

18. A printing apparatus according to claim 17, wherein said positioning mechanism is configured for translating said at least one image capturing device along a plane substantially orthogonal to a viewing direction thereof, and for enabling said at least one image capturing device to become optically aligned with and capture images of a plurality of positions on said at least one focusing plane to selectively provide a plurality of said first capture areas and a plurality of second capture areas.

19. A printing apparatus according to claim 18, wherein said printing apparatus is configured for selectively providing a plurality of said second capture areas on one or another of said substrate and on said stencil, when said substrate or said stencil, respectively, occupy a first position with respect to said at least one image capturing device, wherein in said first position, said substrate or said stencil, respectively, is at a said focusing plane of said optical system.

20. A printing apparatus according to claim 19, wherein said plurality of second capture areas comprise fiducials on a corresponding one of said substrate and said stencil.

21. A printing apparatus according to claim 20, comprising a controller for analyzing image data corresponding to fiducials on said substrate and said stencil and for controlling said mutual superposed positioning thereof.

22. A printing apparatus according to claim 18, wherein said at least one image capturing device is configured to capture an image associated with second capture area, wherein said image comprises a resolution sufficient for determining a position, within a predetermined threshold, of a fiducial on a substrate positioned at a corresponding said focusing plane.

23. A printing apparatus according to claim 19, wherein said first position corresponds to said printing position of said stencil with respect to said frame.

24. A printing apparatus according to claim 18, wherein said printing apparatus is configured for selectively providing a plurality of said first capture areas on said substrate when said substrate occupies a second position with respect to said at least one image capturing device.

25. A printing apparatus according to claim 24, wherein said plurality of first capture areas comprise areas on said substrate wherein said printing material has been deposited via said at least one stencil aperture.

26. A printing apparatus according to claim 24, wherein said second position corresponds to said printing position of said stencil with respect to said frame.

27. A printing apparatus according to claim 24, wherein said first position is aligned along a viewing direction of said at least one image capturing device, and wherein said first position is further distanced therefrom than said printing position of said stencil.

28. A printing apparatus according to claim 24, wherein said at least one image capturing device is configured to capture an image associated with first capture area, wherein said image comprises a resolution sufficient for enabling inspection, within a predetermined threshold, of a printed pattern on a substrate positioned at a corresponding said focusing plane.

29. A printing apparatus according to claim 11, comprising a first said image capturing device and a second said image capturing device configured for focusing with respect to a common said focusing plane, wherein said first image capturing device and said second image capturing device are configured for capturing images at a first field of view and at a second field of view, respectively, wherein said first field of view is larger than said second field of view.

30. A printing apparatus according to claim 11, wherein said image processing device is configured for selectively masking images captured by a said image capturing device to provide image data corresponding to a first capture area that is smaller than a second capture area corresponding to image data provided from corresponding unmasked images captured by said image capturing device.

31. A printing apparatus according to claim 11, wherein said at least one image capturing device comprises an optical zoom module having at least two settings, low zoom and high zoom, wherein at said low zoom, said image capturing device is focused on and enables capture of a first capture area on a said focusing plane at a relatively large field of view, and wherein at high zoom, said image capturing device is focused on and enables capture of a second capture area on the same said focusing plane at a relatively small field of view, and wherein said first capture area is dimensionally larger than said second capture area.

32. A printing apparatus according to claim 11, wherein said at least one image capturing device comprises an optical variable focusing module having at least two settings, a near focus setting and a far focus setting, wherein at said far focus setting, said image capturing device is focused on and enables capture of a first capture area on a first said focusing plane, and wherein at said near focus setting, said image capturing device is focused on and enables capture of a second capture area on a second said focusing plane, wherein said first focusing plane is further displaced from said image capturing device than said second focusing plane, and wherein said first capture area is dimensionally larger than said second capture area.

33. A printing apparatus according to claim 17, wherein a resolution of the image data relating to the second capture area may be greater than the resolution of the image data relating to the first capture area.

34. An optical system for use with printers and the like, comprising:
at least one image capturing device and an image processing device for processing images captured by the or each said image capturing device to provide image data, wherein the optical system is adapted for providing said image data corresponding to at least two capture areas of substantially different dimensions on a common or different said focusing plane of said optical system.

35. A method for printing a material on a substrate via a stencil, comprising:
(a) performing an alignment procedure between a stencil and the substrate based on first image data corresponding to at least one first capture area of each one of said stencil and said substrate, prior to printing the material on the substrate; and
(b) performing an inspection procedure on the printed substrate based on second image data corresponding to at least one second capture area of said substrate;
wherein said at least one first and second capture areas are of substantially different dimensions one from the other.

36. A method according to claim 35, wherein said first image data and said second image data are obtained along a common viewing direction.

37. A method according to claim 35, wherein said second capture area is dimensionally larger than said first capture area, and wherein image data is provided for a plurality of said first capture areas and a plurality of second capture areas.

38. A method according to claim 37, comprising selectively providing a plurality of said first capture areas on one or another of said substrate and on said stencil, when said substrate and said stencil, respectively, alternately occupy a first spatial position.

39. A method according to claim 38, wherein said plurality of first capture areas comprises fiducials on a corresponding one of said substrate and said stencil.

40. A method according to claim 39, wherein step (a) comprises analyzing image data corresponding to said fiducials on said substrate and said stencil, and mutually aligning said stencil and said substrate based on said analysis.

41. A method according to claim 37, comprising selectively providing a plurality of said second capture areas on said substrate when said substrate occupies a second spatial position.

42. A method according to claim 41, wherein step (b) comprises analyzing said plurality of second capture areas on said substrate wherein said printing material has been deposited via said stencil.

43. A method according to claim 38, wherein said first position corresponds to a printing position of said stencil.

44. A method according to claim 38, wherein said second position is displaced form a printing position of said stencil.

45. A method according to claim 35, wherein said first image data is based on at least one image captured at a first field of view and said second image data is based on at least one image captured at a second field of view, wherein said second field of view is larger than said first field of view.

46. A method according to claim 35, wherein said first image data is based on at least one image captured at a first field of view and selectively masked to reduce the image size to provide said image data corresponding to said first capture area, and wherein said second image data is based on at least one image captured at said first field of view to provide said image data corresponding to said second capture area, wherein said first capture area is smaller than said second capture area.

47. A method according to claim 35, wherein said first image data and said second image data are respectively obtained by optically zooming in or out, respectively, from a fixed image capturing position with respect to a focusing plane spatially fixed in relation thereto.

48. A method according to claim 35, wherein said first image data is obtained at a first focusing plane at a first distance from a fixed image capturing position, and said second image data is obtained at a second focusing plane at a second distance from said fixed image capturing position, wherein said second distance is greater than said first distance.

49. A method according to claim 35, wherein a resolution of the image data relating to the second capture area may be greater than a resolution of the image data relating to the first capture area.

50. A method for inspecting a printed substrate, previously printed at a substrate print position via a stencil located at a stencil print position at least during printing of said substrate, comprising:
inspecting the substrate from an inspection position generally superposed over said substrate print position, such that said inspection position is spaced from the substrate at a spacing not less than a spacing between the stencil print position and the substrate.

51. A method according to claim 50, wherein the step of inspecting said substrate is carried out with said substrate located at any one of said substrate printing position, said stencil printing position, or a position below said substrate printing position.

52. A method for inspecting a printed substrate, previously printed at a substrate print position via a stencil located at a stencil print position at least during printing of said substrate, comprising:
inspecting the substrate from an inspection position generally superposed over and vertically aligned with said stencil print position.

53. A method according to claim 52, wherein the step of inspecting said substrate is carried out with said substrate located at any one of said substrate printing position, said stencil printing position, or a position below said substrate printing position.
